(19) United States
(12) Patent Application Publication
(10) Pub. No.: US 2010/0065156 A1
(43) Pub. Date: Mar. 18, 2010

(54) Method for producing rare earth anisotropic bond magnets, method for orientation processing of magnetic molded bodies, and in-magnetic filed molding apparatus

(75) Inventors: Yoshinobu Honkura, Aichi (JP); Aki Watarai, Aichi (JP); Hiroshi Matsuoka, Aichi (JP); Masayuki Kato, Aichi (JP)

Correspondence Address: RADER FISHMAN & GRAUER PLLC, LION BUILDING, 1233 20TH STREET N.W., SUITE 501, WASHINGTON, DC, 20036, US

(73) Assignee: Aichi Steel Corporation, Aichi (JP)

(21) Appl. No.: 12/461,667

(22) Filed: Aug. 20, 2009

Related U.S. Application Data
(63) Continuation of application No. PCT/JP2008/066591, filed on Sep. 12, 2008.

(51) Int. Cl. H01F 1/08; B28B 17/00

(52) U.S. Cl. 148/103; 425/3

(57) ABSTRACT

The present invention relates to a method for producing a rare earth anisotropic bond magnet containing a hollow cylindrically shaped magnetic molded body having, at the hollow cylindrically shaped side face thereof, at least 4 or more orientation portions that are oriented with semi-radial distribution by compression molding of a magnetic material after thermally orienting step, wherein intermediate aligning magnetic fields applied in the thermally orienting step to between adjacent cavities are the mostly same in their magnetic directions. A plurality of rare earth anisotropic bond magnets can be efficiently produced at one time.

### TECHNICAL FIELD

The present invention relates to a production method suitable for production of rare earth anisotropic bond magnets, a magnetic molded body orientation processing method for use in the production, and an in-magnetic field molding apparatus.

### BACKGROUND ART

A rare earth anisotropic bond magnet (also referred to hereinafter as simply “bond magnet”), even in small size, attains high magnetic flux density and has a high degree of freedom of configuration. Accordingly, the bond magnet is molded for example in the form of a (hollow) cylinder and used as a permanent magnet for motor and the like. Such a bond magnetic is subjected to orientation processing at a stage of molding before magnetization, in order to attain high magnetic flux density by taking advantage of magnetic powder.

On one hand, in the field of small-sized engine brush motors represented by automobile small-sized brush motors, ferrite 2-pole motors using 2-pole ferrite sintered magnets as a magnetic field system have been mainly used. Recently, however, there is demand for motors to be small-sized while maintaining the same output power and to have higher output power, in order to make riding in car comfortable and to improve automobile fuel economy, and the like. This leads to the advent of a motor using a hollow cylindrically shaped rare earth anisotropic bond magnet, which has 4 or more magnetic poles in the radial direction. This high-performance motor, as compared with the conventional ferrite 2-pole motor with the same performance, can be reduced significantly to about ½ in volume. In the above field, therefore, the multipole motor using a rare earth anisotropic bond magnet is being substituted for the conventional ferrite 2-pole motor (see, for example, Patent Document 5 below).

Further, in order to improve the cogging torque of the high-performance motor, innovations in the orientation processing of a hollow cylindrically shaped rare earth anisotropic bond magnet having 4 or more poles in the radial direction have been proposed in Patent Document 1 or 2 below. That is, these documents disclose that the orientation processing is performed to attain not the conventional radial orientation but the so-called semi-radial orientation, thereby increasing the output torque of the motor and reducing the cogging torque.

In order to increase the production efficiency of such a bond magnet, the in-magnetic field moldability of a plurality of magnetic molded bodies in a multi-cavity in-magnetic field molding apparatus (molding in a multi-cavity in-magnetic field molding apparatus) is preferable. Orientation processing methods correlated therewith are proposed in Patent Documents 3 and 4 below.

Patent Document 1: Japanese Unexamined Patent Publication (KOKAI) No. 2004-23085

Patent Document 2: Japanese Unexamined Patent Publication (KOKAI) No. 2005-312167

Patent Document 3: Japanese Unexamined Patent Publication (KOKAI) No. 2007-103606

Patent Document 4: Japanese Examined Patent Publication (KOKOKU) No. 6-24175

Patent Document 5: Japanese Patent Publication No. 3480733

### DISCLOSURE OF INVENTION

### Problem to be Solved by the Invention

In the orientation processing described in Patent Document 3, the direction of the orientation is that of the so-called axial orientation, but not that of the semi-radial orientation. As used herein, the orientation refers to magnetic field orientation and means that in order to align the axis of easy magnetization of anisotropic magnetic powder in a predetermined direction, an aligning magnetic field is applied in that direction, whereby the axis of easy magnetization of the anisotropic magnetic powder is rotated so as to align in the direction of the magnetic field. If conducted so, this orientation processing method cannot be said to be preferable for bond magnets for high-efficiency motors, as is also evident from a description of Patent Documents 1 and 2 supra. As used herein, the axial orientation means that the axis of easy magnetization of rare earth anisotropic magnetic powder (also referred to hereinafter as “magnetic powder”) is oriented in the uniaxial direction (that is, in the direction of the cylinder axis) of a bond magnet (a magnetic molded body), while the radial orientation means that the axis of easy magnetization is oriented radially from the central axis of a bond magnet. Particularly, the radial orientation of a hollow cylindrically shaped bond magnet means that the axis of easy magnetization is oriented in a direction normal to the hollow cylindrically shaped side face of the bond magnet.

As used herein, the semi-radial distribution refers to the distribution of the axes of easy magnetization of anisotropic magnetic powders (group) in a hollow cylindrically shaped rare earth anisotropic bond magnet wherein the anisotropic magnetic powders (group) in the rare earth anisotropic bond magnet have, in the main polar part of the magnetic pole, an axis of easy magnetization of the anisotropic magnetic powder in a direction normal to the hollow cylindrically shaped side face of the bond magnet, and in a transition segment between the magnetic poles, the axis of easy magnetization of the anisotropic magnetic powder steadily points towards a direction tangential to the periphery of the hollow cylindrically shaped side face of the magnet at points closer to the neutral point of the magnetic pole, and becomes the direction tangential to the periphery of the hollow cylindrically shaped side face at that neutral point, and steadily points toward the direction normal to the hollow cylindrically shaped side at points farther away from the neutral point. The semi-radial orientation, which means that anisotropic magnetic powders (group) in a rare earth anisotropic bond magnet are oriented to have semi-radial distribution by an aligning magnetic field, is distinguished from the generally called radial orientation in that not all axes of easy magnetization are directed in the radial direction (that is, the axes are not uniformly directed and vary depending on the position where the anisotropic magnetic powder is located).

Patent Document 4 proposes radial orientation processing capable of molding in a multi-cavity in-magnetic field molding apparatus. However, in its orientation processing as shown in FIG. 7A, magnetic fields passing in the vertical direction in the figure are opposed to each other (repel each other) between adjacent magnetic molded bodies (cavities). In this direction, therefore, sufficient orientation is not achieved. The arrows in FIG. 7A are those added to a diagram (FIG. 8) in Patent Document 4 and indicate the direction of magnetism. FIG. 7B shows the result of the present inventors' FEM analysis based on the in-magnetic field molding apparatus shown in FIG. 7A, and indicates the strength of the magnetic field by the density of lines of magnetic force. From FIG. 7B, it can be known that the magnetic fields are weakened by being opposed to each other (repelling each other) in the vertical direction in the diagram, and simultaneously the strength of the aligning magnetic field changes depending on the position of the cavity. Such orientation processing method in Patent Document 4 may be effective for ferrite magnetic powder to be oriented in a small magnetic field, but is not suitable as a method for orientation processing of rare earth anisotropic bond magnets demanded to attain high output power and requiring a large magnetic field in their orientation.

In a hollow cylindrically shaped ring magnetic manufactured by this orientation processing method, there appear regions with insufficient surface magnetic flux density attributable to the strength of the aligning magnetic field in the hollow cylindrically shaped direction. Accordingly, a motor equipped with this ring magnet is subject to a decrease in motor output power and an increase in cogging torque. Under these circumstances, simultaneous production of a plurality of hollow cylindrically shaped rare earth anisotropic bond magnets having 4 or more magnetic poles in the radial direction in one in-magnetic field molding apparatus has not been conducted.

Patent Document 1 (see FIG. 6) also proposes semi-radial orientation processing capable of molding in a multi-cavity in-magnetic field molding apparatus, but in view of the magnetic field passing between adjacent magnetic molded bodies (cavities), two orientation portions have magnetic flux closed in ring 51 as a back yoke. Accordingly, the orientation portions are magnetically independent of each other. Although the orientation portions are magnetically independent, a die 30 uneconomically intervenes therebetween, thus readily rendering the apparatus large-sized. When this apparatus in Patent Document 1 is used, the aligning magnetic field is formed by a magnet, so that when moldings are removed after orientation processing, the magnetic field cannot be cut off. Accordingly, the magnetic powder in the moldings is pulled by the aligning magnetic field and thus easily damaging the moldings. When the moldings are completely cured to prevent them from being damaged, about 30 minutes are required each time the molding is conducted, to significantly lower productivity.

The present invention has been made in light of these circumstances, and an object of the present invention is to provide a method for producing rare earth anisotropic bond magnets, wherein high-performance hollow cylindrically shaped rare earth anisotropic bond magnets having 4 or more magnetic poles in the radical direction can be effectively produced, as well as a method for orientation processing of magnetic molded bodies which is suitable for the production method. Another object of the present invention is to provide an in-magnetic field molding apparatus which is suitable for these methods and can be small-sized.

### Means for Solving the Problem

To solve this problem, the inventors made extensive study and repeated the process of trial and error, and as a result, they conceived that the major magnetic directions of intermediate aligning magnetic fields applied among adjacent cavities are made uniform in acquiring a plurality of magnetic molded bodies. The inventors thereby succeeded in simultaneously acquiring a plurality of hollow cylindrically shaped rare earth anisotropic bond magnets each having 4 or more magnetic poles in the radial direction, while using a relatively small in-magnetic field molding apparatus. As a matter of course, bond magnets obtained by this method, as compared with the conventional bond magnet obtained singly with a single-cavity apparatus, are free of a reduction in magnetic characteristics in the circumferential direction and so on. The inventors further developed this result, thereby arriving at completion of various inventions described below.

### <Method for Producing Rare Earth Anisotropic Bond Magnets>

(1) In other words, the method for producing rare earth anisotropic bond magnets according to the present invention is a method comprising the steps of:

charging at least two hollow cylindrically shaped cavities arranged adjacently in a direction parallel to the central axis thereof, with a magnetic material containing at least one kind of rare earth anisotropic magnetic powder and a binder resin;

after the charging step, thermally orienting the magnetic material by heating at a temperature equal to or higher than the softening point of the resin to soften or melt the resin and simultaneously applying aligning magnetic fields to allow the rare earth anisotropic magnetic powder to be oriented with semi-radial distribution;

compression-molding the magnetic material oriented after or during the thermally orienting step, thereby obtaining hollow cylindrically shaped magnetic molded bodies having, in the hollow cylindrically shaped side thereof, at least 4 or more oriented portions oriented with semi-radical distribution; and

magnetizing the magnetic molded bodies such that the magnetized oriented portions serve as magnetic poles,

wherein the intermediate aligning magnetic fields applied in the thermally orienting step to the adjacent cavities are the mostly same in their magnetic directions.

(2) Even if a plurality of bond magnets are acquired at least in the thermal orienting step, a uniform aligning magnetic field can be applied to each cavity according to the method for producing rare earth anisotropic bond magnets according to the present invention. Particularly, the aligning magnetic fields that penetrate between the adjacent cavities respectively are intermediate aligning magnetic fields that are the mostly same in their magnetic directions, whereby an almost uniform aligning magnetic field can be applied to each of the orientation portions in opposing magnet moldings in the adjacent cavities. In this manner, high-performance rare earth anisotropic bond magnets with stabilized qualities can be produced efficiently and simultaneously in the multi-cavity in-magnetic field molding apparatus.

By performing such a thermal orienting step, the in-magnetic field molding apparatus for use in orientation processing can be considerably made smaller than when single-cavity in-magnetic field molding apparatuses are connected simply in parallel.

### <Method for Orientation Processing of Magnetic Molded Bodies>

Thus, the present invention is characterized by the orientation processing method for a magnetic material and can thus be grasped not only as a method for producing rare earth anisotropic bond magnets but also as a method for orientation processing of magnetic molded bodies, which is suitable for rare earth anisotropic bond magnets.

That is, the present invention can also serve as a method for orientation processing of magnetic molded bodies, comprising the steps of:

charging at least two hollow cylindrically shaped cavities arranged adjacently in a direction parallel to the central axis thereof, with a magnetic material containing at least one kind of rare earth anisotropic magnetic powder and a binder resin;

after the charging step, thermally orienting the magnetic material by heating at a temperature equal to or higher than the softening point of the resin to soften or melt the resin and simultaneously applying aligning magnetic fields to allow the rare earth anisotropic magnetic powder to be oriented with semi-radial distribution; and

compression-molding the magnetic material oriented after or during the thermally orienting step, thereby obtaining hollow cylindrically shaped magnetic molded bodies having, in the hollow cylindrically shaped side face thereof, at least 4 or more oriented portions oriented with semi-radical distribution,

wherein the intermediate aligning magnetic fields applied in the thermally orienting step to the adjacent cavities are the mostly same in their magnetic directions.

### <In-Magnetic Field Molding Apparatus>

(1) In the present invention, the aligning magnetic fields that penetrate between the adjacent cavities respectively are intermediate aligning magnetic fields that are the mostly same in their magnetic directions as described above, thus enabling economical formation of magnetic loops that penetrate the orientation portions of each cavity. Accordingly, yokes (including dice, etc. used as dies) constituting the magnetic circuit arranged between the adjacent cavities can be reduced in size, and the in-magnetic field molding apparatus for use in the thermal orienting step can also be small-sized.

(2) Accordingly, the present invention can be grasped not only as the method for producing rare earth anisotropic bond magnets and the method for orientation processing of magnetic molded bodies but also as an in-magnetic field molding apparatus which can be applied to the methods. That is, the present invention also relates to an in-magnetic field molding apparatus capable of producing hollow cylindrically shaped magnetic molded bodies having, in their hollow cylindrically shaped side face, at least 4 or more orientation portions oriented with semi-radial distribution, comprising:

at least two hollow cylindrically shaped cavities arranged adjacently in a direction parallel to the central axis thereof, and a core serving as a magnetic core at the side of the inner periphery of the cavity;

a main yoke divided into at least quarters or more with non-magnetic portions intervening thereamong, and arranged approximately circularly at the side of the outer periphery of the cavity, the main yoke being made of a magnetic material;

a heater capable of heating a magnetic material containing at least one kind of rare earth anisotropic magnetic powder and a binder resin charged into the cavity, at a temperature equal to or higher than the softening point of the resin to soften or melt the resin;

a magnetic field source capable of applying an aligning magnetic field in the direction from the main yoke to the magnetic material charged in the cavity; and

a punch applying pressure on the magnetic material charged in the cavity,

wherein the apparatus further comprises an intermediate yoke made of a magnetic material by which the main yokes arranged between the adjacent cavities are connected magnetically to each other, and is capable of applying, via the intermediate yoke, intermediate aligning magnetic fields that are the mostly same in their magnetic directions, to the adjacent cavities.

Particularly, the magnetic field source is preferably one having both an intermediate electromagnetic coil wound around the intermediate yoke and a current source supplying a current in a definite direction to the intermediate electromagnetic coil.

(3) The magnetic field source that generates an aligning magnetic field may use the magnetomotive force of a permanent magnetic or may use electromagnetic power obtained by supplying a current to an electromagnetic coil. In either case, it is effective to form a magnetic circuit with less magnetic resistance in order to efficiently apply an intermediate aligning magnetic field. Accordingly, an intermediate yoke made of a magnetic material is preferably arranged between the adjacent cavities. When an electromagnetic coil is wound about a surrounding area of this intermediate yoke, the intermediate yoke also serves as a magnetic core.

Accordingly, the magnetic field source in the in-magnetic field molding apparatus of the present invention, for example, is preferably composed of an intermediate yoke arranged between the adjacent cavities and made of a magnetic material, an electromagnetic coil wound about a surrounding area of the intermediate yoke, and a current source supplying a current in a definite direction to the electromagnetic coil.

### (Others)

(1) In the present invention, the number of orientation portions formed in the periphery of a magnetic molded body, or the number of magnetic poles formed on a rare earth anisotropic bond magnet after magnetization of the orientation portions, is not particularly limited, but in consideration of higher performance, higher efficiency, etc. of an instrument in which the bond magnet is used, the number is 4 or more. When the bond magnet is used as a motor bond magnet (particularly, a DC motor bond magnet), the number of orientation portions therein is usually an even number, and thus the number is preferably 4, 6, 8, 10 or the like.

(2) The method for producing rare earth anisotropic bond magnets according to the present invention may include a step of densifying the magnetic molded bodies by further compression (thermal compression), a step of rigidly thermally curing the thermosetting resin used in the magnetic material (thermally curing step), a magnetization step, a rust preventing step, etc. in addition to the charging step, the thermal orienting step and the molding step described above. In this case, the respective steps may be carried out independently, or 4 or more steps may be carried out at the same time. For example, a weighing step of obtaining powder moldings obtained by previously compression molding weighed magnetic material powder, and the thermal orienting step described above, may be conducted separately or at the same time. When the steps are conducted separately, so-called batch processing becomes possible to enhance mass productivity. When the steps are conducted at the same time, burden on facilities can be reduced. This also applies to the densifying step conducted after the thermal orienting step and molding step.

(3) Unless otherwise noted, “x to y” referred to in this specification includes the lower limit x and upper limit y. In addition, it is to be noted that the lower and upper limits described in this specification can be arbitrarily combined to constitute a range such as “a to b”.

### BRIEF DESCRIPTION OF DRAWINGS

FIG. 1A is a diagram showing a basic structure of an in-magnetic field molding apparatus in the Examples.

FIG. 1B is an I-I sectional view of FIG. 1A.

FIG. 1C is a detailed drawing of a die in the in-magnetic field molding apparatus shown in FIG. 1A.

FIG. 1D is a diagram showing magnetic loops formed around a cavity of the in-magnetic field molding apparatus shown in FIG. 1A.

FIG. 2A is a diagram showing adjacent arrangement of the conventional single-cavity in-magnetic field molding apparatuses.

FIG. 2B is a diagram wherein the in-magnetic field molding apparatuses shown in FIG. 2A are arranged respectively with back yokes therebetween being reduced in width.

FIG. 3 is a diagram showing a 2-cavity in-magnetic field molding apparatus in the Examples.

FIG. 4 is a graph showing relative angle distributions, in magnetic flux density, of radial components measured in the ring-shaped bond magnets in the Examples.

FIG. 5 is a diagram showing a 4-cavity in-magnetic field molding apparatus in the Examples.

FIG. 6 is a diagram showing another 4-cavity in-magnetic field molding apparatus in the Examples.

FIG. 7A is a diagram showing a conventional multi-cavity in-magnetic field molding apparatus.

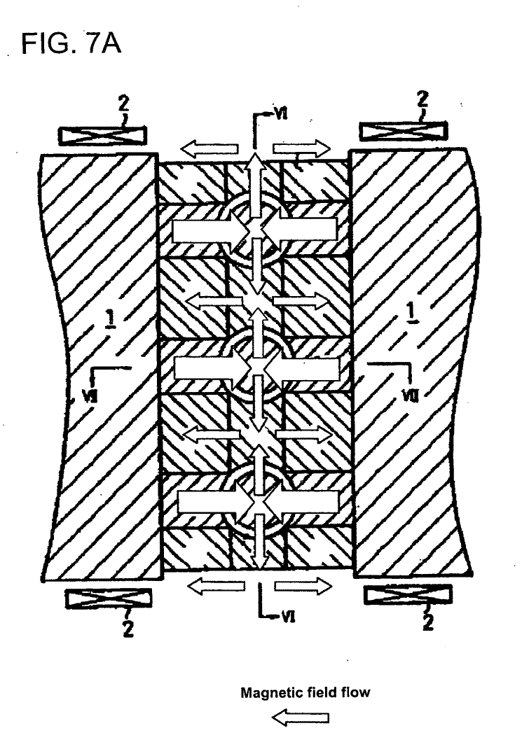

FIG. 7B is a diagram of FEM analysis of magnetic directions around cavities in the multi-cavity in-magnetic field molding apparatus in FIG. 7A.

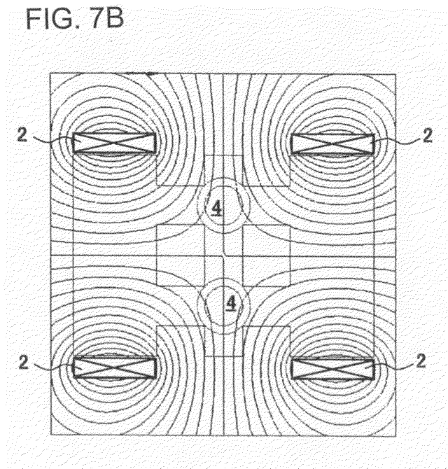

### DESCRIPTION OF REFERENCE NUMERALS

S2: in-magnetic field molding apparatus
C1, C2: cavities
11: intermediate yoke
12: back yoke
13: electromagnetic coil

### Best Mode for Carrying out the Invention

The present invention is described in more detail by reference to the embodiments of the present invention. The disclosure of this specification, including the following embodiments, is related not only to the method for producing rare earth anisotropic bond magnets according to the present invention, but also appropriately to the method for orientation processing of magnetic molded bodies and the in-magnetic field molding apparatus. Whether a certain one of the embodiments is best or not varies depending on the subject, required performance, etc., and in the present invention, one or more constitutions can be selected from those constitutions described in this specification and added to the above-described constitution. The selected constitutions can be added synthetically and arbitrarily beyond category to any of the inventions. It is to be noted that a constitution related to the process can, when understood as product-by-process, also become a constitution related to “product”.

### (1) The Method for Producing Rare Earth Anisotropic Bond Magnets and the Method for Orientation Processing of Magnetic Molded Bodies

The method for producing rare earth anisotropic bond magnets or the method for orientation processing of magnetic molded bodies in the present invention comprises the steps described above, and in either case, the thermal orienting step is important, and therefore, the thermal orienting step is additionally described below.

The thermal orienting step is a step in which the resin in the magnetic material charged in the cavity is heated until the resin is softened or molten, followed by applying an aligning magnetic field, whereby the rare earth anisotropic magnetic powder is oriented with semi-radial distribution. In this step, the aligning magnetic field is applied from the side face of the periphery of the cavity, whereby the rare earth anisotropic magnetic powder is oriented (semi-radially oriented) in specific orientation portions. As a result, hollow cylindrically shaped magnetic molded bodies each having at least 4 or more orientation portions in the hollow cylindrically shaped side face thereof can be obtained. The heating temperature, heating time, molding pressure, and the strength of the aligning magnetic field to be applied vary depending on the type and compounding ratio of the resin and rare earth anisotropic magnetic powder as the magnetic material, specifications required for the rare earth anisotropic bond magnet, and so on. By way of example, the heating temperature where a thermosetting resin is used is for example about 120 to 180° C. The molding pressure is for example about 50 to 500 MPa, and the time required for the thermal orienting step is about 0.5 to 10 seconds. The strength of the aligning magnetic field applied, although varying depending on the viscosity of the thermosetting resin, is for example about 0.4 to 1.8 T.

The terms “soften” and “molten” referred to the present invention cannot be strictly distinguished from each other. In short, this condition of the resin suffices if the resin is heated to reduce its viscosity such that each particle of the rare earth anisotropic magnetic powder can be rotated, transferred, etc.

### (2) Magnetic Material

The magnetic material contains at least one kind of rare earth anisotropic magnetic powder and a binder resin. Specific examples of the magnetic material include mixed powder of rare earth anisotropic magnetic powder and resin powder, a compound obtained by heating and kneading the mixed powder, a powder molding obtained by compression molding of the mixed powder or the compound, and a mixture of rare earth anisotropic magnetic powder and molten resin, etc. The magnetic material may contain not only the rare earth anisotropic magnetic powder and the resin, but also other additives, such as a lubricant, a curing agent, a curing assistant and a surfactant.

The composition, type, etc. of the rare earth anisotropic magnetic powder are not limited, and any of known magnetic powders can be used. Typical examples of the rare earth anisotropic magnetic powder include Nd—Fe—B type magnetic powder, Sm—Fe—N type magnetic powder, SmCo type magnetic powder, etc. These magnetic powders may be those produced by the so-called rapid solidification process or those produced by a hydrogenation treatment method (d-HDDR (hydrogenation, disproprotination, desorption, and recombination) process or HDDR process).

The rare earth anisotropic magnetic powders may be used alone or as a mixture of two or more thereof. For example, a mixture of coarse powder having a relative large average particle size (for example, 1 to 250 μm) and fine powder having a relatively small average particle size (for example, 1 to 10 μm) may be used.

As the resin, known materials are used and examples of such materials include polyamide synthetic resins such as nylon and nylon 6, homopolymerized or copolymerized vinyl synthetic resins, such as polyvinyl chloride, vinyl acetate copolymers thereof, MMA, PS, PPS, PE and PP, thermoplastic resins such as urethane, silicone, polycarbonate, PBT, PET, PEEK, CPE, Hypalon, neoprene, SBR and NBR, and thermosetting resins, such as epoxy resin, phenol resin and melamine resin. The resin may be adhered in a powder form to the particle surface of the rare earth anisotropic magnetic powder or may be coated in the form of a film on the particle surface.

For the releasability of a molding, regulation of molding timing, and improvements in the wettability and adhesion between the magnetic powder and molten resin and so on, various additives may be incorporated in a small amount. Such additives include lubricants such as zinc stearate, aluminum stearate, and alcohol-based lubricants, titanate- or silane-based coupling agents, curing agents such as 4,4′-diaminodiphenylmethane (DDM) and hardening accelerators such as TPP-S (trade name, manufactured by Hokko Chemical Industry Co., Ltd.).

The mixing ratio by volume of the rare earth anisotropic magnetic powder to the resin is established such that the magnetic powder is 80 to 90% by volume and the resin is about 10 to 20% by volume. In terms of mass ratio, the magnetic powder is 95 to 99% by mass and the resin is about 1 to 5% by mass. The additives may be added in an amount of about 0.1 to 0.5% by volume.

### (3) Rare Earth Anisotropic Bond Magnet

The rare earth anisotropic bond magnet in the present invention has a plurality of magnetic poles emitting magnetic fluxes with semi-radial distribution, from the hollow cylindrically shaped inner and outer peripheral sides. Its use, shape, size, magnetic characteristics, etc are not limited.

The rare earth anisotropic bond magnet is typically used as a field magnet in a motor. The motor may be a direct-current (DC) motor or an alternating-current (AC) motor. It may be an inverter-controllable induction motor or the like. The position in which the rare earth anisotropic bond magnet is disposed may be at the side of a rotor, at the side of a stator, or at the side of the inner or outer periphery relative to the central axis.

### EXAMPLES

The present invention will be described in more detail with reference to the Examples.

### <Method for Producing Rare Earth Anisotropic Bond Magnets>

In this example, the production of a permanent magnet housed in a housing of a 4-pole DC brush motor, which is a ring-shaped bond magnet (rare each anisotropic bond magnet) in the form of a hollow cylinder constituting a magnetic field system for the motor, will be described with reference to one example of the method for producing rare earth anisotropic bond magnets according to the present invention. Specifically, the ring-shaped bond magnet in this example is produced in the following manner.

### (1) Magnetic Material

A magnetic material containing rare earth anisotropic magnetic powder and resin was prepared. This magnetic material was prepared by compression molding a compound obtained by heat-kneading an Nd—Fe—B type (for example, Nd: 12.5% (atomic %), B: 6.4%, Ga: 0.3%, Nb: 0.2%, and the balance Fe) rare earth anisotropic magnetic powder (hereinafter referred to simply as “magnetic powder”) obtained by d-HDDR treatment (see Japanese Patent No. 3250551, Japanese Patent No. 3871219, etc.), with a thermosetting resin, that is, an epoxy resin (hereinafter referred to simply as “resin”).

The compounding ratio of the resin in the compound was for example 1 to 5% by mass based on 100% by mass of the compound as a whole. The rare earth anisotropic magnetic powder used herein is the Nd—Fe—B type magnetic powder with which Sm—Fe—N type magnetic powder, etc. having a smaller particle size may be mixed (see Japanese Patent No. 3731597, etc.).

In this example, this compound was not directly used; that is, this compound was weighed out in a desired amount and then slightly compression-molded into a desired shape to give a formed body for use as the magnetic material. By so doing, the weighing step can be separated from a thermal orienting step, etc. described below. As a result, it is not only possible to improve the handleability of the magnetic material, the mass productivity of bond magnets, etc., but is also possible to perform weighing of the compound and molding of the formed body in such a cold state that the weighing is made accurate to make quality of the resulting bond magnet uniform.

### (2) Thermal Orienting Step and Molding Step

The magnetic material (formed body) described above is charged into a cavity of an in-magnetic field molding apparatus (which will be described later) (charging step). Then, the magnetic material is heated to soften the resin, followed by applying an aligning magnetic field (thermal orienting step) and subsequent compression molding (molding step). A magnet molding on which a ring-shaped bond magnet is to be based can thereby be obtained. The conditions established in the thermal orienting step or the molding step are for example as follows: heating temperature, 120 to 180° C.; molding pressure, 50 to 500 MPa; aligning magnetic field, 0.4 to 1.5 T; and processing time, 0.5 to 10 seconds.

In this example, the magnetic molded body obtained after the molding step described above, without being subjected to further thermal/compression molding, was formed by 2-stage molding, that is, by molding the compound into a formed body and subsequent thermal orientation molding of the formed body. When a dense, highly accurate ring-shaped bond magnet is to be obtained, a densifying step of thermal compression at higher temperatures and higher pressure may be additionally conducted after the molding step described above. In this case, the process is a 3-stage molding process.

### (3) Thermal Curing Step and Magnetization Step

The resulting magnetic molded body was further subjected to thermal curing treatment under heating to thermally cure the epoxy resin in the magnetic material (thermal curing step). A ring-shaped bond magnet of high strength with excellent heat resistance is thereby obtained. The magnetic molded body thus subjected to thermal curing treatment is magnetized, whereby a ring-shaped bond magnet oriented semi-radially in 4 poles for use in a 4-pole DC brush motor can be obtained as described later. The thermal curing treatment is carried out by keeping the magnetic molded body for about 15 to 60 minutes in a furnace at 140 to 180° C.

The magnetization step is carried out by providing the ring-shaped bond magnet with a soft magnetic core and a soft magnetic yoke at the sides of the inner and outer peripheries of the ring-shaped bond magnet, respectively, and then applying a magnetic field thereto in a radial direction mainly perpendicular to the central axis of the ring-shaped bond magnet. This magnetic field is not necessarily in the same direction as that of the aligning magnetic field and may be in a uniform radial direction. The magnetic field in this case may naturally be a magnetic field with the same semi-radial distribution as that of the aligning magnetic field. In this case, the same magnetization apparatus as in an in-magnetic field molding apparatus described later can be used to magnetize a plurality of magnet moldings at the same time. For magnetization, a pulse magnetic field at about 2 to 5 T was used.

### <In-Magnetic Field Molding Apparatus>

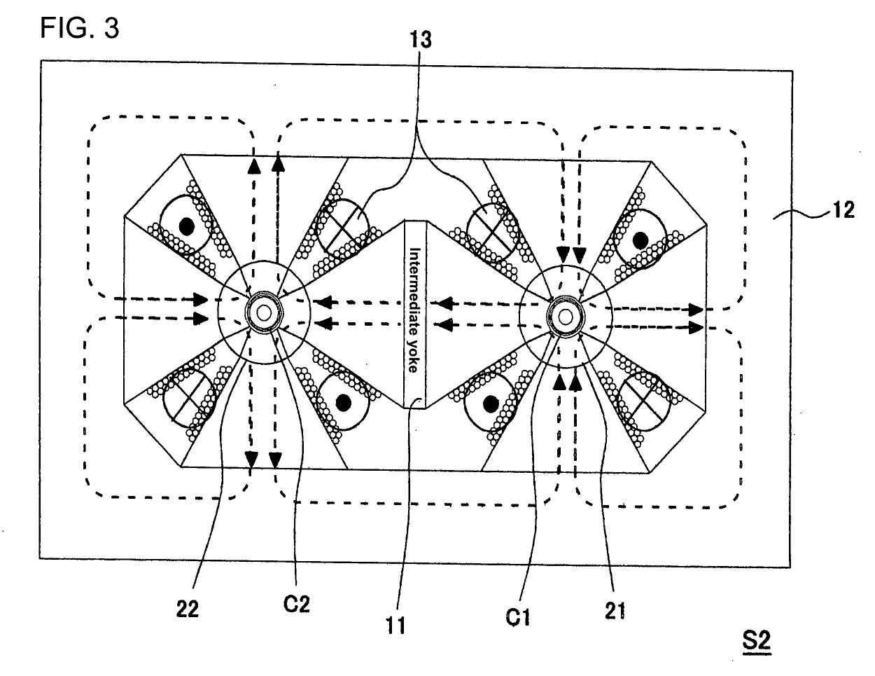

An in-magnetic field molding apparatus in which the aforementioned thermal orienting step and the molding step can be carried out will be described. By way of example, the in-magnetic field molding apparatus S2 shown in FIG. 3 was used in this example to mold 2 magnetic molded bodies simultaneously (molding in the 2-cavity molding apparatus).

### (1) Basic Structure

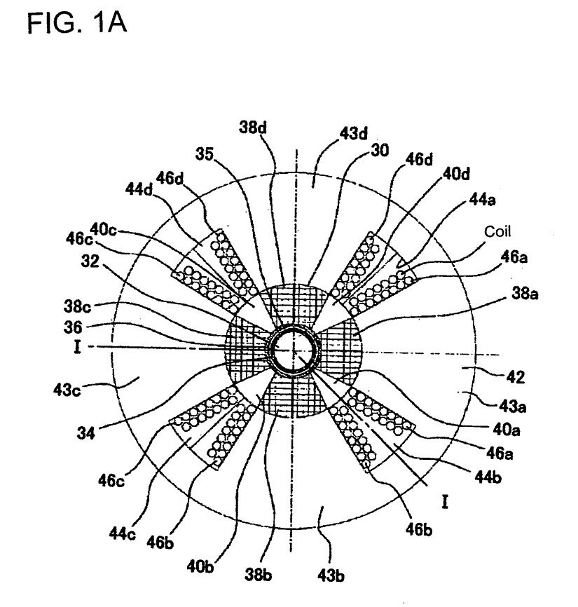

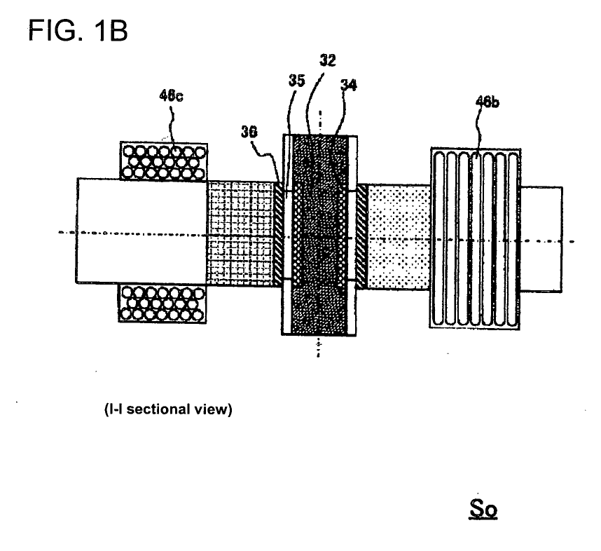

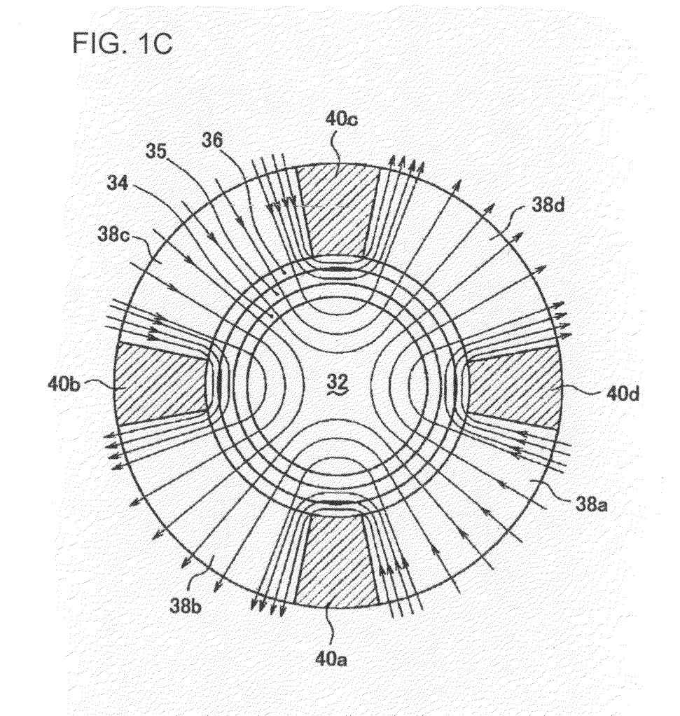

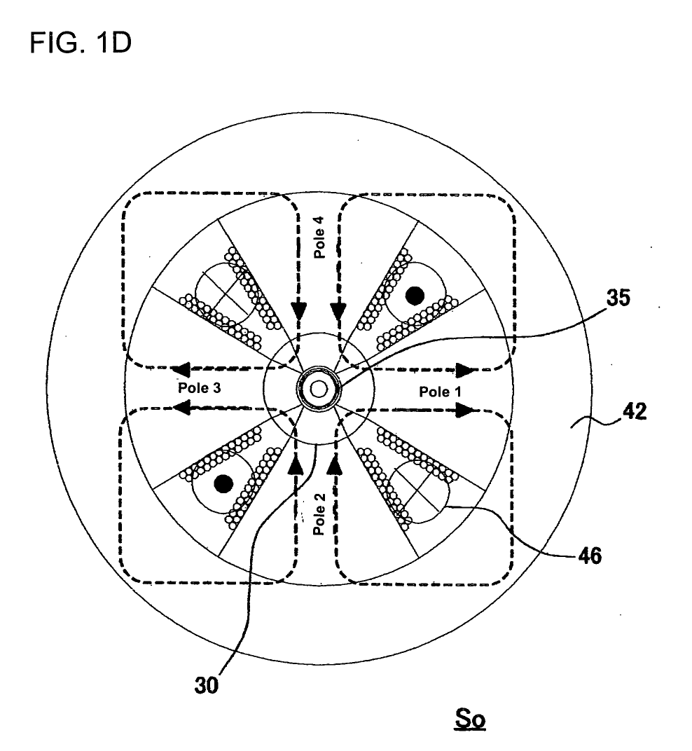

First, the basic structure of an in-magnetic field molding apparatus So (also referred to hereinafter as “apparatus So”) on which the in-magnetic field molding apparatus S2 is based will be described with reference to FIGS. 1A to 1D. These drawings show only 1 cavity to simply explain the basic structure of the in-magnetic field molding apparatus. FIG. 1A is a plane sectional view of the apparatus So; FIG. 1B is a longitudinal sectional view of the apparatus So; and FIG. 1C is a detailed sectional view, on the periphery of the cavity, of the apparatus So.

The apparatus So includes a die 30, a back yoke 42, an electromagnetic coil 46 (a magnetic field source), a high-frequency induction heater (not shown) for heating and softening the resin in the magnetic material, and a punch (not shown) for compression molding of the magnetic material in the cavity.

The die 30 includes a cylindrical core 32 arranged in the center and made of a soft magnetic material, a hollow cylindrically shaped first ring 34 fitted and inserted in such a manner as to surround the outer periphery of the core 32, the hollow cylindrically shaped first ring 34 being made of a ferromagnetic superhard material, and a hollow cylindrically shaped second ring 36 arranged at the side of the outer periphery of the first ring 34 and with a certain clearance formed between itself and the first ring 34, the hollow cylindrically shaped second 36 being made of a ferromagnetic superhard material. A circular cavity 35 is formed between the first ring 34 and the second ring 36.

The second ring 36 is provided on the outer periphery thereof with quarter-divided and approximately fan-shaped first dices 38a, 38b, 38c and 38d (main yoke) formed of a ferromagnetic material and approximately fan-shaped second dices 40a, 40b, 40c and 40d (non-magnetic portions) arranged between the first dices and made of a nonmagnetic material such as stainless steel, etc. The length of the circular arc of the second ring 36 with which the second dice 40a, 40b, 40c or 40d is contacted is set to be sufficiently shorter than the length of the circular arc of the second ring 36 with which the first dice 38a, 38b, 38c or 38d is contacted. The aforementioned die 30 is composed of the first dice 38 and the second dice 40 in addition to the core 32, the first ring 34 and the second ring 36.

The die 30 is provided outside of the outer periphery thereof with a circular back yoke 42 connected magnetically to the first dices 38a, 38b, 38c and 38d, respectively and constituting a magnetic circuit. The first dices 38a, 38b, 38c and 38d are connected to the back yoke 42 magnetically via fan-shaped yoke pieces 43a, 43b, 43c and 43d, respectively.

Electromagnetic coils 46a, 46b, 46c and 46d are wounded about spaces 44a, 44b, 44c and 44d divided and formed by the respective yoke pieces 43a, 43b, 43c and 43d. For example, adjacent two spaces 44a and 44b are wound with the electromagnetic coil 46a such that the yoke piece 43a located therebetween is contained. One example of the direction of electric current supplied to the wound electromagnetic coil 46 is shown in FIG. 1D. In FIG. 1D, mark X indicates the direction of current flow from the front side to back side of the plane of this diagram, while mark • indicates the direction of current flow from the back side to front side of the plane of this diagram. By changing the direction of current flowing in the conducting wires of the electromagnetic coils 46a, 46b, 46c and 46d, the direction of the generated magnetic field can be changed. The direction of current is regulated by the winding direction of each electromagnetic coil or by changing the connection direction of a power source to an electrode.

When an electric current in the direction shown in FIG. 1D flows in the electromagnetic coil 46, electromagnetic poles 1 to 4 shown in this diagram are formed, and major magnetic loops indicated by the broken lines in this diagram are formed. Specifically, the magnetic lines passing through the annular cavity 35, as shown in FIG. 1C, are formed.

When the aforementioned thermal orienting step is conducted under application of this magnetic field, a magnetic molded body, which is oriented semi-radically in 4 orientation portions which are approximately symmetrical in the vertical and horizontal directions respectively, is obtained. As shown in FIG. 1C, the 4 orientation portions are formed by transition segments where the magnetic lines are greatly changed.

As used herein, the orientation refers to magnetic field orientation, and means that for orienting the axis of easy magnetization of anisotropic magnetic powder in a predetermined direction, an aligning magnetic field is applied in the predetermined direction, thereby rotating the axis of easy magnetization of the anisotropic magnetic powder along the direction of the magnetic field. The semi-radial orientation means that anisotropic magnetic powders (group) in a rare earth anisotropic bond magnetic are oriented to have semi-radiation distribution by an aligning magnetic field. The semi-radial distribution refers to the distribution of the axes of easy magnetization of anisotropic magnetic powders (group) in a hollow cylindrically shaped rare earth anisotropic bond magnet wherein the anisotropic magnetic powders (group) in the rare earth anisotropic bond magnet have, in the main polar region of the magnetic pole, an axis of easy magnetization in a direction normal to the hollow cylindrically shaped side of the bond magnet, and in a transition segment between the magnetic poles, the axis of easy magnetization of the anisotropic magnetic powder steadily points towards a direction tangential to the periphery of the hollow cylindrically shaped side of the magnet at points closer to the neutral point of the magnetic pole, and becomes the direction tangential to the periphery of the hollow cylindrically shaped side face at that neutral point, and steadily points toward the direction normal to the hollow cylindrically shaped side face at points farther away from the neutral point. The semi-radial orientation is distinguished from the generally called radial orientation in that not all axes of easy magnetization are directed in the radial direction (that is, the axes are not uniformly directed and vary depending on the position where the anisotropic magnetic powder is located).

The magnetic molded body thus obtained is magnetized, so that for example, an S pole appears on the inner surface of the cylinder in an orientation portion formed corresponding to the yoke piece 43a, while an N pole appears on the inner surface of the cylinder in an orientation portion formed corresponding to the yoke piece 43b. Similarly, an S pole appears on the inner surface of the cylinder in an orientation portion formed corresponding to the yoke piece 43c, while an N pole appears on the inner surface of the cylinder in an orientation portion formed corresponding to the yoke piece 43d. In this way, a field magnet for use in a 4-pole DC brush motor, which feeds magnetic flux to an armature, can be obtained.

### (2) Structure of the Multi-Cavity In-Magnetic Field Molding Apparatus

Based on the basic structure described above, the structure of the in-magnetic field molding apparatus S2 in this example, in which 2 ring-shaped magnetic molded bodies can be obtained by performing the thermal orienting step once, will be described in due order.

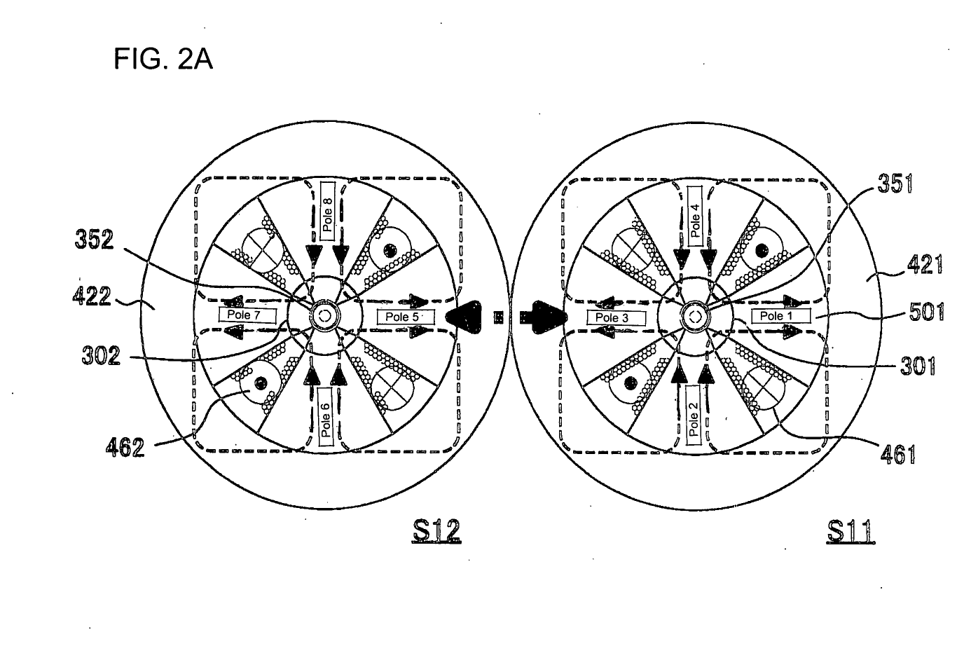

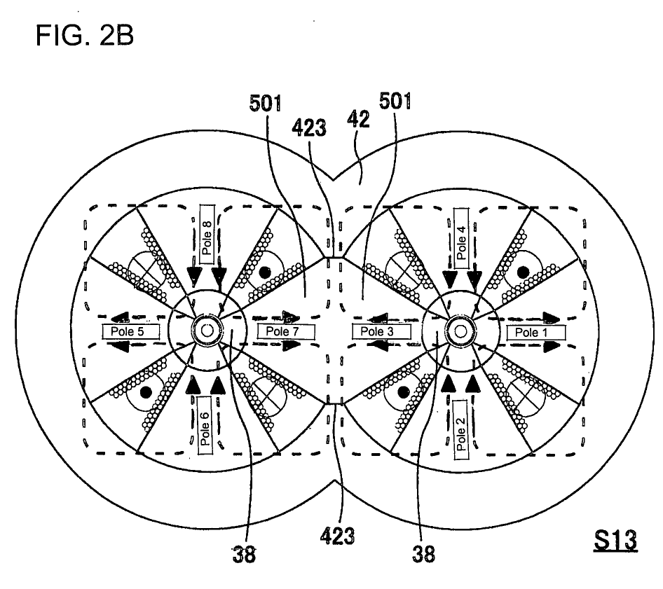

First, FIG. 2A shows an arrangement in which in-magnetic field molding apparatuses S11 and S12, each of which is a single-cavity in-magnetic field molding apparatus, are connected in parallel and include the dies 301 and 302, back yokes 421 and 422, electromagnetic coils 461 and 462, etc., corresponding respectively to the aforementioned die 30, the back yoke 42, the electromagnetic coil 46, etc. In this case, as can be clearly seen from FIG. 2A, the distance between the adjacent cavities 351 and 352 is increased, the back yokes 421 and 422 have a wasteful space therebetween, and thus the apparatus cannot be reduced in size.

Accordingly, when the back yokes 421 and 422 are simply reduced in width to reduce the distance between the cavities as shown in FIG. 2B, a back yoke connection portion 423 serving as a magnetic path between the back yokes 421 and 422 is narrowed. Accordingly, saturated magnetic flux is reached in the back yoke connection portion 423, which results in failure to apply a sufficient aligning magnetic field to the pole of the cavity connected to the back yoke connection portion 423 via the dice 38 and the yoke 501. As a result, the strength of the aligning magnetic field applied is not uniform depending on the pole of the cavity.

It follows that in this example as shown in FIG. 3, an intermediate yoke 11 made of a ferromagnetic material is arranged between the first rings 21 and 22 constituting the adjacent cavities C1 and C2, the electromagnetic coils 13 at both sides of cavities C1 and C2 with the intermediate yoke 11 arranged therebetween are supplied with an electric current flowing in the same direction, and, at the same time, an approximately squarely annular back yoke 12 are provided to surround both the cavities C1 and C2.

By this structure, the magnetomotive force generated by the electromagnetic coil 13 is passed through the intermediate yoke 11 also serving as a magnetic core, to produce an aligning magnetic field (intermediate aligning magnetic field) having the same main magnetic direction, and applied to the cavities C1 and C2. The orientation by this intermediate aligning magnetic field acts on the orientation portions of cavities C1 and C2 respectively, so that the magnetomotive force of the electromagnetic coil 13 is made about twice as high as the magnetomotive force of the electromagnetic coil in other portions than in the intermediate aligning orientation field (for example, in the outer periphery). When the electric current supplied from a power source (not shown) is equal among all electromagnetic coils of the in-magnetic field molding apparatus S2 (for example, when the respective electromagnetic coils are connected in series), the number of turns of the wires wound wires around the electromagnetic coil 13 may be approximately twice as much as that of other portions. For orientation of the 4-pole ring-shaped bond magnetic as in this example, electric current flowing in the electromagnetic coil 13 may be directed as shown in FIG. 3. A description of constituent members in the in-magnetic field molding apparatus S2 shown in FIG. 3, which have structures and functions common to those of the constituent members in the in-magnetic field molding apparatus So shown in FIG. 1A to FIG. 1D, is omitted herein.

### (3) Evaluation

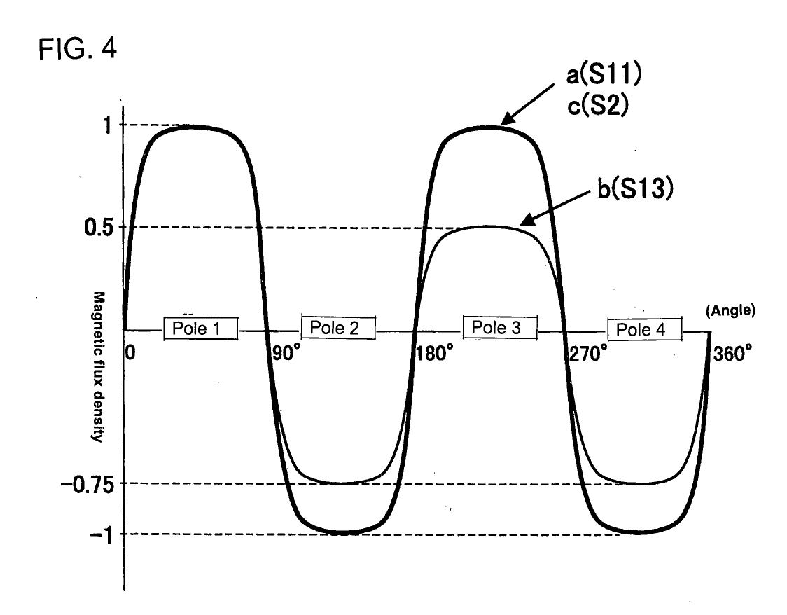

The magnetic characteristic of one ring-shaped bond magnet (poles 1 to 4) obtained by the in-magnetic field molding apparatus S2 in this example, the magnetic characteristic of one ring-shaped bond magnet (poles 1 to 4) obtained by the in-magnetic field molding apparatus S11 shown in FIG. 2A (that is, an apparatus constituted by merely arranging two conventional in-magnetic field molding apparatuses between which a magnetic field does not interfere), and the magnetic characteristic of one ring-shaped bond magnet (poles 1 to 4) obtained by the in-magnetic field molding apparatus S13 shown in FIG. 2B, were measured. The results are shown in FIG. 4. The magnetic characteristic measured herein is an angle distribution of radial components in surface magnetic flux density of the ring-shaped bond magnet. The magnetic flux density shown in FIG. 4 is a relative value and shows a flux change in each pole relative to a flux change as a standard of the ring-shaped bond magnet obtained by the in-magnetic field molding apparatus S11. FIG. 4 shows the standard flux change as flux curve “a” whose maximum and minimum values are shown as ±1. As is also evident from FIG. 4, the flux curve “a” has characteristics that the distribution of the magnetic flux density in each pole is uniform.

The flux change of the ring-shaped bond magnet obtained by the in-magnetic field molding apparatus S13 is shown as flux curve “b”. In this case, the back yoke connection portion 423 is so narrow that the aligning magnetic field in its portion reaches saturated magnetic flux, thus reducing magnetic loops (magnetic flux passing therethrough) passing from pole 3 to pole 4 and magnetic loops passing from pole 3 to pole 2. As a result, the strength of the magnetic field in the cavity portion corresponding to the pole 3 is significantly reduced, and the strength of the magnetic field in the cavity portions corresponding to the poles 4 and 2 is also significantly reduced, and thus sufficient orientation cannot be attained in these portions. That is, when a plurality of bond magnets are simultaneously obtained using the multi-cavity in-magnetic field molding apparatus S13, an aligning magnetic field equivalent to that of the conventional single-cavity in-magnetic field molding apparatus S11 or the like cannot be output. More specifically, it can be said that as is evident from comparison between the flux curve “b” and the flux curve “a”, the peak value of the flux density in the flux curve “b” is reduced to about 50% in pole 3, and to about 75% in poles 2 and 4, relative to the peak value of the flux density in the flux curve a. Accordingly, it is not preferable that the ring-shaped bond magnet obtained by the in-magnetic field molding apparatus S13 is used in a motor, because the torque of the motor is significantly reduced and the cogging torque based in unevenness of flux density is increased.

In the case of the ring-shaped bond magnet obtained by the in-magnetic field molding apparatus S2 in this example, on the other hand, it can be seen that an aligning magnetic field equivalent to that (shown by the flux curve “a”) of the conventional single-cavity in-magnetic field molding apparatus S11 or the like has been output, as is apparent from the flux curve “c” showing the change of the magnetic flux. This is because the apparatus S2, unlike the in-magnetic field molding apparatus S13, does not have a narrow portion in the magnetic path and thus does not have a portion in which upon application of an aligning magnetic field, there is no portion where magnetic flux is reduced on magnetic loops.

### (4) Other Examples

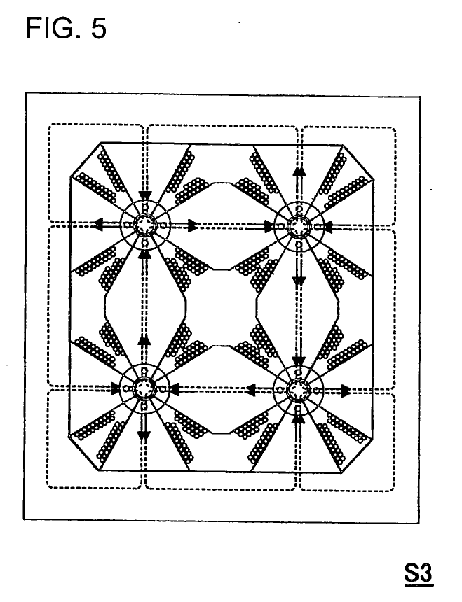

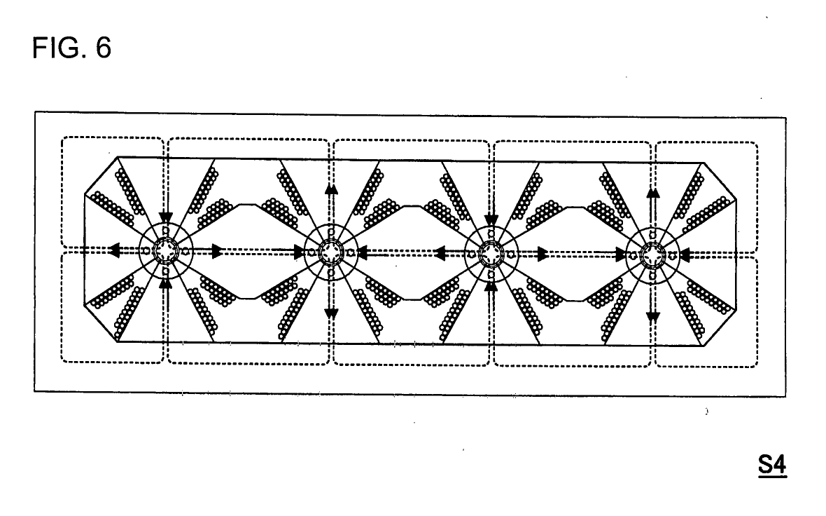

FIG. 5 shows an in-magnetic field molding apparatus S3 in which 4 magnetic molded bodies can be obtained by performing the thermal orienting step once. The broken lines shown in FIG. 5 are magnetic loops, and the magnetic loops extending adjacently in parallel are shown to have the same magnetic direction. FIG. 6 shows another in-magnetic field molding apparatus S4 in which 4 magnetic molded bodies can be obtained by performing the thermal orienting step once, similar to the in-magnetic field molding apparatus S3 shown in FIG. 5.

The in-magnetic field molding apparatus S3 has cavities which are arranged evenly vertically and horizontally so that 4 (2×2) products can be obtained, while the in-magnetic field molding apparatus S4 have 4 cavities vertically in one stage and horizontally in series wherein 4 (1×4) products can be obtained. The broken lines shown in FIG. 6 are also magnetic loops, and the magnetic loops extending adjacently in parallel are shown to have the same magnetic direction.

Further, the in-magnetic field molding apparatus in which a plurality of products can be obtained (the multi-cavity in-magnetic field molding apparatus) is not limited to one having cavities arranged in a linear or rectangular form. As long as the magnetic direction of a magnetic field generated in the intermediate yoke arranged between the adjacent cavities is the same aligning magnetic field (intermediate aligning magnetic field), the cavities may be arranged in the form of a triangle, hexagon, etc.

1. A method for producing rare earth anisotropic bond magnets, comprising the steps of:
charging at least two hollow cylindrically shaped cavities arranged adjacently in a direction parallel to the central axis thereof, with a magnetic material containing at least one kind of rare earth anisotropic magnetic powder and a binder resin;
after the charging step, thermally orienting the magnetic material by heating at a temperature equal to or higher than the softening point of the resin to soften or melt the resin and simultaneously applying aligning magnetic fields to allow the rare earth anisotropic magnetic powder to be oriented with semi-radial distribution;
compression-molding the magnetic material oriented after or during the thermally orienting step, thereby obtaining hollow cylindrically shaped magnetic molded bodies having, in the hollow cylindrically shaped side face thereof, at least 4 or more oriented portions oriented with semi-radical distribution; and
magnetizing the magnetic molded bodies such that the magnetized oriented portions serve as magnetic poles,
wherein an intermediate aligning magnetic fields applied in the thermal orienting step to the adjacent cavities are the mostly same in their magnetic directions.

2. A method for orientation processing of magnetic molded bodies, comprising the steps of:
charging at least two hollow cylindrically shaped cavities arranged adjacently in a direction parallel to the central axis thereof, with a magnetic material containing at least one kind of rare earth anisotropic magnetic powder and a binder resin;
after the charging step, thermally orienting the magnetic material by heating at a temperature equal to or higher than the softening point of the resin to soften or melt the resin and simultaneously applying aligning magnetic fields to allow the rare earth anisotropic magnetic powder to be oriented with semi-radial distribution; and
compression-molding the magnetic material oriented after or during the thermally orienting step, thereby obtaining hollow cylindrically shaped magnetic molded bodies having, in the hollow cylindrically shaped side face thereof, at least 4 or more oriented portions oriented with semi-radical distribution,
wherein an intermediate aligning magnetic fields applied in the thermally orienting step to the adjacent cavities are the mostly same in their magnetic directions.

3. An in-magnetic field molding apparatus capable of producing hollow cylindrically shaped magnetic molded bodies having, in their hollow cylindrically shaped side, at least 4 or more orientation portions oriented with semi-radial distribution, comprising:
at least two hollow cylindrically shaped cavities arranged adjacently in a direction parallel to the central axis thereof, and a core serving as a magnetic core at the side of the inner periphery of the cavity;
a main yoke divided into at least quarters or more with non-magnetic portions intervening thereamong, and arranged approximately circularly at the side of the outer periphery of the cavity, the main yoke being made of a magnetic material;
a heater capable of heating a magnetic material containing at least one kind of rare earth anisotropic magnetic powder and a binder resin charged into the cavity, at a temperature equal to or higher than the softening point of the resin to soften or melt the resin;
a magnetic field source capable of applying an aligning magnetic field in the direction from the main yoke to the magnetic material charged in the cavity; and
a punch applying pressure on the magnetic material charged in the cavity,
wherein the apparatus further comprises an intermediate yoke made of a magnetic material by which the main yokes arranged between the adjacent cavities are connected magnetically to each other, and is capable of applying, via the intermediate yoke, intermediate aligning magnetic fields that are the mostly same in their magnetic directions, to the adjacent cavities.

4. The in-magnetic field molding apparatus according to claim 3, wherein the magnetic field source has both an intermediate electromagnetic coil wound about the intermediate yoke and a current source supplying a current in a definite direction to the intermediate electromagnetic coil.
